(19) United States
(12) Patent Application Publication
(10) Pub. No.: US 2010/0113239 A1
(43) Pub. Date: May 6, 2010

(54) METHOD FOR MAKING A FLEXIBLE RECLOSABLE PACKAGE

(75) Inventor: Robert J. Peterson, Crystal Lake, IL (US)

Correspondence Address: WM. WRIGLEY JR. COMPANY;Patent Department, 1132 WEST BLACKHAWK STREET, CHICAGO, IL, 60622, US

(73) Assignee: WM. WRIGLEY JR. COMPANY, Chicago, IL (US)

(21) Appl. No.: 12/531,934

(22) PCT Filed: Mar. 5, 2008
(86) PCT No.: PCT/US08/55889

§ 371 Date: Sep. 18, 2009

(30) Foreign Application Priority Data
Mar. 21, 2007 (US) 60896092

(51) Int. Cl. B31B 1/25; B31B 19/14; B31B 23/00; B31B 1/88; B31B 1/64; B31B 1/90

(52) U.S. Cl. 493/187; 493/210; 493/213; 493/240; 493/264

(57) ABSTRACT

A method of forming a flexible packaging laminate (30) that has a reclosable opening (20). The method includes forming a two-part laminate that has an outer structure (40) joined in face-to-face relation with an inner structure (60). Score lines (122,142) are formed in both structures (40,60) to enable an opening to be formed through the laminate by lifting an opening portion (e.g., a flap or the.like) of the two structures out of the plane of the laminate. The score line (122) through the outer structure defines a larger opening than the score line (142) through the inner structure, such that a marginal region of the outer structure extends beyond the edge of the opening portion of the inner structure. A pressure-sensitive adhesive (92) is used to re-adhere the marginal region to an underlying surface of the inner structure adjacent the opening through the laminate.

The present invention relates to methods for making a flexible reclosable package.

A variety of food and non-food products are packaged using flexible packaging materials formed primarily of laminations of one or more of polymer films, metallized polymer films, paper, metal foil, and the like. There is a desire to be able to reclose a package after its initial opening to keep product that remains in the package fresh. US 2005/0276525 describes such a package and a method for making the package. Briefly the process requires two film structures to be adhered to each other and then each film structure is scored at a location in registration with a strip of adhesive. The present invention improves on the process described in that application.

### SUMMARY

According to one embodiment of the present invention, the flexible package is formed in the following manner. One or more film layers are laminated to form an outer layer structure. A pressure-sensitive adhesive is pattern-applied onto one surface of the outer layer structure to form a strip having an outer perimeter and an inner perimeter. A permanent laminating adhesive is pattern-applied onto the one surface of the outer structure such that the permanent adhesive does not cover the strip of pressure-sensitive adhesive. An outer line of weakness (also referred to as a “score line”) is formed through the thickness or at least a part of the thickness of the outer structure. The outer structure may also be printed in a conventional manner.

An inner layer structure is formed by laminating one or more film layers. The inner layer structure and the outer layer structure are joined to form a laminate. Thereafter, an inner line of weakness (also referred to as a “score line”) is formed through the thickness or at least a part of the thickness of the inner structure. The inner score line penetrates through the thickness of the inner layer structure but not through the outer layer structure. The outer structure and inner structure in certain embodiments are coextensive with each other. The formed laminate can be advanced to a take up roll where it can be unwound in a filling and sealing process, the details of which are known and do not form part of the present invention.

Advantageously, the score line created in the inner layer structure may be registered with respect to one or more of the printing on the outer layer structure, the outer line of weakness on the outer layer structure, and/or the pattern of the pressure sensitive adhesive on the outer layer structure. In addition, the outer score line in the outer layer structure can be formed without risk of scoring the inner layer structure since the inner layer structure and the outer layer structure are not yet laminated to each other. In addition, the inner layer structure can be laminated to the outer layer structure at any location of the inner layer structure, which simplifies the lamination process. The score lines can be formed by laser scoring or by mechanical scoring or cutting such as by die cutting, kiss cutting, or the like.

The strip of pressure-sensitive adhesive is such that neither score line is located where there is permanent laminating adhesive between the outer and inner structures. The outer score line delineates the outer opening portion of the outer structure that is separable from the outer structure along the outer score line, and the inner score line delineates the inner opening portion of the inner structure that is affixed to the outer opening portion by the permanent adhesive and is separable from the inner structure along the inner score line. The pressure-sensitive adhesive can be applied such that there is a region that is free of the adhesive to form a thumb tab or grasping portion of the opening portion that can be readily grasped and pulled back to initiate opening.

It is within the scope of the invention to use only pressure-sensitive adhesive, with no permanent laminating adhesive. In this instance, the pressure-sensitive adhesive is used to join the outer layer structure to the inner layer structure over their entire surfaces. The adhesive(s) can be applied to the outer structure as noted, but alternatively can be applied to the inner structure. The adhesive(s) can be applied using any suitable equipment and technique, such as by a gravure roll or the like.

The inner layer structure of the laminate may include a sealant layer forming the inner surface of the laminate. The sealant layer can comprise a heat seal material such as polyethylene, polypropylene, ionomer resin such as SURLYN® or the like, or a cold seal material. The heat seal or cold seal layer can comprise either a film or a coating. The inner structure may also include a barrier layer to provide a barrier against the passage of moisture and/or oxygen. In some applications such as the packaging of moisture-sensitive products (e.g., products that tend to be degraded when exposed to the environment), it is important to provide a moisture barrier. The barrier layer can comprise any of various polymer-based barrier materials including barrier polymer films such as ethylene vinyl alcohol copolymer (EVOH), polyamide, and the like; metallized polyolefin films such as polyethylene, polypropylene, oriented polypropylene, and the like; AlOx-coated polymer films; SiOx-coated polymer films; metal foil such as aluminum foil; and others. Although the term “barrier layer” is used in connection with metallized films to refer to the entire metallized film, it will be recognized that it is the layer of metal that provides the barrier function. Likewise, it is the AlOx or SiOx coating that provides the barrier function in the ceramic-coated films, but the entire film nevertheless is referred to herein as a “barrier layer”.

The outer structure may include a layer of polyester such as polyethylene terephthalate, that may have a desirable crisp feel and can be readily printed. The polyester layer can be printed with inks to provide graphics and indicia. In some embodiments, the polyester layer is transparent and is reverse-printed on the surface that faces the inner structure.

### BRIEF DESCRIPTION OF THE DRAWINGS

FIG. 1 is a diagrammatic depiction of a method for making a flexible package according to the present invention.

FIG. 2 is a view of the outer layer structure before being laminated to the inner layer structure and after being scored but without any printing.

FIG. 3 is a perspective view of a package that can be formed according to the method of the present invention shown in a closed position.

FIG. 4 is a perspective view of a package that can be formed according to the method of the present invention shown in an open position.

FIG. 5 is a cross-sectional view of a portion of the package in a closed configuration.

FIG. 6 is a cross-sectional view of a portion of the package in an open configuration.

FIG. 7 is a diagrammatic depiction of a method for making a flexible package according to the present invention, which contains features that can be used in the process depicted in FIG. 1.

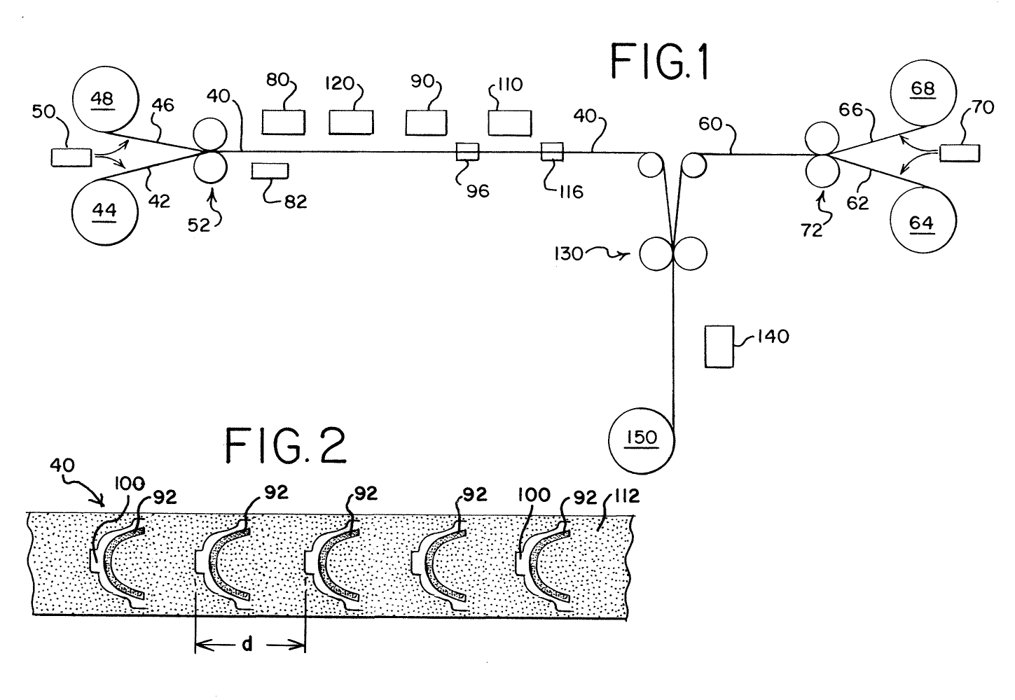

### DETAILED DESCRIPTION

The invention is described with reference to the drawings in which like elements are referred to by like numerals. The relationship and functioning of the various elements of this invention are better understood by the following description. Each aspect so defined may be combined with any other aspect or aspects unless clearly indicated to the contrary. The embodiments described below are by way of example only, and the invention is not limited to the embodiments illustrated in the drawings.

As an initial overview of the invention, a flexible package 10 is provided with a built-in opening and reclose function, e.g., a resealable flap 20. The package 10 is formed from a laminate 30 that is constructed as a multi-layer structure by scoring a first structure 40 and then adhesively laminating the first structure 40 to a second structure 60. The scoring operation performed on the first structure 40 results in penetration through the first structure 40 without concern of penetration through the second structure 60, since the first structure 40 and second structure 60 are not yet joined. Once the laminate 30 is formed in this manner, the second structure 60 is scored in registration with the scoring on the first structure 40, the adhesive patterns and/or the printing formed on the first structure 40. The scoring operation performed on the second structure 60 results in penetration through the second structure 60, but without complete penetration through the first structure 40, and preferably without any substantial penetration, and more preferably without any penetration, into the first structure 40. Each of the first 40 and second structures 60 may include one or more layers of flexible material(s). Permanent and pressure-sensitive adhesives are applied to one of the structures in predetermined patterns.

Turning now to FIG. 1, one embodiment of the manufacturing process of the present invention is depicted. A first structure 40 is formed by joining a first layer 42 with a second layer 46. The first layer 42 may be advanced from a supply roll 44 and the second layer 46 may be advanced from a different supply roll 48. Adhesive 50 may be applied to the first layer 42, the second layer 46, or both. Thereafter, the first layer 42 and the second layer 46 may be joined in a laminating station 52 to form the first structure 40.

Alternatively, the first structure 40 may be supplied from a roll of preformed first structure laminate 200 (as best seen in FIG. 7). In addition, while FIG. 1 shows the first structure 40 being formed from two film layers, it is contemplated that the first structure 40 could be formed from more than two layers, e.g., from three or more layers. In addition, the formed first structure 40 could be rolled up on a spool 200 for later processing, as described below.

Various materials can be used for the layer(s) of the first structure 40, including polymers such polyesters, polyolefins (including homopolymers and copolymers), polyamides, and others; paper; metal foil; and the like. Advantageously, when metal foil is used as an inner layer, it allows partial scoring through the outer layer while maintaining structural integrity for later operations such as scoring, batch rolling, transporting, batch unrolling, and the like.

The first structure 40 may then be advanced by suitable web driving and handling equipment (not shown) to an optional print station 80 comprising a printing apparatus, such as a rotogravure printer or the like, for printing graphics and/or indicia on the first structure by applying inks to a surface of the first structure 40. In one embodiment of the invention, the first structure 40 includes an outer layer that is substantially transparent and may be reverse-printed in the print station so that the inks will be visible through the first structure 40. The inks may be applied to the surface of the first structure 40 that is subsequently laminated to another structure, as described below; from the opposite side of the first structure, which will form an exterior of a package 10 constructed from the laminate 30.

Prior to printing the first structure 40 at the print station 80, the surface of the first structure 40 to be printed can be treated by a corona discharge or flame treatment apparatus 82 to render the surface more-receptive to the inks and/or to render the surface more-readily bondable to the pressure-sensitive adhesive that is subsequently pattern-applied to the surface as described below.

Following the optional corona/flame treatment and/or optional printing operation, the first structure 40 may be advanced to the next processing stage or it may be rolled up onto a spool 202 (as best seen in FIG. 7) and stored for subsequent processing operations.

The first structure 40 either from the previous processing step or from roll 202 is advanced to a scoring station 120 where a first score line 122 is formed through the thickness of the first structure 40. The first score line 122 is in registration with (i.e., coincides with) the printing of the graphics or indicia or other features. The first score line 122 extends substantially through the thickness of the first structure 40.

The first scoring station 120 can comprise a laser. The use of lasers for scoring through flexible materials is generally known, for example as described in U.S. Pat. Nos. 3,909,582 and 5,229,180, the contents of which are incorporated herein by reference. The depth of the score line formed by the laser can be regulated by regulating the power output or beam intensity of the laser beam, the width or spot size of the laser beam, and the amount of time a given spot on the film surface is irradiated by the beam. These factors generally are selected based on the characteristics of the material being scored. Some materials are more readily scored by lasers than other materials, as known in the art.

As noted, the first score line 122 should be in registration with one or more features such as printing, indicia marks, the location of the outer perimeter of the pressure-sensitive adhesive strip 92 (and the outer perimeter of the thumb tab 100, if present, where the scoring is conducted after application of the adhesives), or other features that can be used to accurately locate the score line. To accomplish this registration, the operation of the laser is controlled to be synchronized with the advancement of the first structure. A sensor disposed adjacent the first structure can be used to detect a feature on the first structure (such as printing) whose location in relation to the strip of pressure-sensitive adhesive 92 is known, and the sensor's output signal can be used by a suitable controller (not shown) for controlling the laser. Subsequent to the scoring, the first structure 40 may be rolled onto spool 204 for subsequent processing (as best seen in FIG. 7).

After scoring, the first structure may be advanced (either from spool 204 or from the previous continuous scoring station) to a first adhesive application station 90 at which a pressure-sensitive adhesive 92 may be applied to the first structure 40 in a predetermined pattern that recurs at regular intervals along the lengthwise direction of the first structure 40. The predetermined pattern may be in the form of a strip of various forms or shapes. As illustrated, one shape for the strip pattern may be generally U-shaped or smile shaped, for reasons that will become apparent. Other shapes for the pattern can be used. The pattern can include a region that is free of adhesive 100 and that will ultimately form a thumb tab or grasping portion of the first structure 40 as further described below.

The pressure-sensitive adhesive 92 can comprise various compositions. Pressure-sensitive adhesives form viscoelastic bonds that are aggressively and permanently tacky, adhere without the need of more than a finger or hand pressure, and require no activation by water, solvent or heat. Pressure-sensitive adhesives are often based on non-crosslinked rubber adhesives in a latex emulsion or solvent-borne form, or can comprise acrylic and methacrylate adhesives, styrene copolymers (SIS/SBS), and silicones. Acrylic adhesives are known for excellent environmental resistance and fast-setting time when compared with other resin systems. Acrylic pressure-sensitive adhesives often use an acrylate system. Natural rubber, synthetic rubber or elastomer sealants and adhesives can be based on a variety of systems such as silicone, polyurethane, chloroprene, butyl, polybutadiene, isoprene, or neoprene. When the packaging laminate of the invention is to be used for food packaging, the pressure-sensitive adhesive generally must be a food-grade composition. Various pressure-sensitive adhesives are approved by the U.S. Food and Drug Administration for use in direct food contact, as regulated by 21 CFR Part 175.300. Food-grade pressure-sensitive adhesives are preferred for use in the present invention. Additives (e.g., particulates or the like) can be added to the pressure-sensitive adhesive to reduce the tenacity of the bond to the second structure 60, if necessary, so that the pressure-sensitive adhesive 92 readily detaches from the second structure 60 on opening (particularly on the very first opening).

The pattern of pressure-sensitive adhesive 92 is applied to the first structure 40 at regular intervals along the first structure 40. The spacing or index distance d between the patterns can correspond to a dimension, such as a length, of packages 10 to be produced from the laminate 30.

The adhesive application station 90 can comprise any suitable device capable of accurately applying the pressure-sensitive adhesive 92 to the first structure 40 in the desired pattern at regular intervals along the first structure 40. For example, the adhesive application station 90 can comprise one or more gravure rolls that pick up the pressure-sensitive adhesive 92 from a reservoir on the outer surface of the roll such that the adhesive fills one or more recessed areas in the surface. A doctor blade may then be used to scrape off excess adhesive so that it remains essentially only in the recessed area(s). The first structure 40 may be contacted by the gravure roll with a backing roll that may be used to provide support on the opposite side of the first structure 40.

After application of the pressure-sensitive adhesive 92, the first structure 40 may be advanced to a dryer 96 such as an oven or the like, to dry the pressure-sensitive adhesive 92. The first structure 40 may then advanced to a second adhesive application station 110 at which a permanent laminating adhesive 112 is applied to the first structure 40 in such a manner that a sufficiently large proportion of the surface is covered by the permanent adhesive 112 to permit the first structure 40 to be adhesively attached to a second structure 60 at a downstream laminating station 130. Alternatively, the first structure 40 may be advanced to the second adhesive application station 110 before being advanced to the dryer 96. Thereafter, the first structure 40, which contains both the pressure-sensitive adhesive 92 and the permanent laminating adhesive 112, is advanced to the dryer 116 to dry the adhesives.

The permanent adhesive 112 does not cover the pressure-sensitive adhesive 92. Furthermore, when the pattern of pressure-sensitive adhesive 92 includes an adhesive-free region 100 to form a thumb tab or grasping portion as previously noted, the pattern of the permanent adhesive 112 also does not cover the adhesive-free region 100. Thus, the permanent adhesive 112 should be applied by an apparatus capable of accurately applying the permanent adhesive 112 in a predetermined pattern, in registration with the pressure-sensitive adhesive 92 but not covering it or the adhesive-free region 100, if present. A suitable adhesive application device can be a gravure roll of the type previously described.

The permanent adhesive 112 can comprise various compositions. Suitable examples include two-component polyurethane adhesive systems, such as Tycel 7900/7283 available from Henkel.

While FIG. 1 depicts a certain order of processing of the first structure 40, it is contemplated that the various processing steps can be varied according to manufacturing and processing desires. Thus, for example, it may be desirable to apply adhesives prior to scoring.

After the application of the adhesives and any optional drying, the first structure 40 is advanced to a laminating station 130 that can include a pair of rolls forming a nip therebetween. The first structure 40 is passed through the nip along with a second structure 60 that is separately advanced, and the first structure 40 is laminated to the second structure 60.

As noted above, the second structure 60 is advanced separately from the first structure 40 to the laminating station 130. The second structure 60 may be formed from one or more layers. The second structure 60 may be coextensive with the first structure 40, i.e., the width of the second structure 60 may be substantially equal to the width of the first structure 40 and the longitudinal edges of the second structure 60 substantially coincide with the longitudinal edges of the first structure 40.

The second structure 60 may be supplied as one or more layers as shown in FIG. 7. For example, the second structure 60 may include only one layer when a metallic layer is included with the first structure 40.

As shown in FIG. 1, the second structure 60 may be formed from two layers. In this instance, the second structure 60 is formed by joining a first layer 62 with a second layer 66. The first layer 62 may be advanced from a supply roll 64 and the second layer 66 may be advanced from a different supply roll 68. Adhesive 70 may be applied to the first layer 62, the second layer 66, or both. Thereafter, the first layer 62 and the second layer 66 may be joined in a laminating station 72 to form the second structure 60. Additionally, either or both of the first or second layers may be a multi-layer laminate from a previous lamination operation.

Alternatively, the second structure 60 may be supplied from a roll of preformed second structure laminate. In addition, while FIG. 1 shows the second structure 60 being formed from two film layers, it is contemplated that the second structure 60 could be formed from more than two layers, e.g., from three or more layers.

After the laminate 30 is formed, the laminate 30 may be rolled up on roll 206 for storage and later processing as shown in FIG. 7. Alternatively, as shown in FIG. 1, the laminate is advanced to a second scoring station 140 at which a second score line 142 is formed through the thickness of the second structure 60. The second score line 142 is in registration with (i.e., coincides with) the inner perimeter of the strip-shaped pattern of pressure-sensitive adhesive 92. The second score line 142 extends substantially through the thickness of the second structure 60, but preferably does not extend to any substantial extent into the first structure 40, as illustrated in FIG. 5.

The second scoring station 140 can comprise a laser. The operation of the laser is synchronized with the advancement of the laminate 30. A sensor can detect a feature, such as an eye mark or printing, on the laminate 30 whose location in relation to the pressure-sensitive adhesive strip 92 is known, and the sensor output can be used for regulating the laser operation so that the second score line 142 is in registration with the inner perimeter of the pressure-sensitive adhesive strip 92.

As an alternative to the use of lasers for scoring the laminate, the score lines can be formed by mechanical scoring or cutting. For instance, the first scoring station 120 can comprise a kiss roll and backing roll that form a nip through which the first structure is passed. The kiss roll may include a rotary cutting die defining a cutting edge (not shown). The kiss roll acts in conjunction with the backing roll to cut partially through the thickness of the first structure 40 starting from the outer surface of the first structure, such that the first structure 40 is substantially scored through. The second scoring station 140 may likewise comprise a kiss roll and backing roll for scoring through the second structure 60. The kiss roll acts in conjunction with the backing roll to cut partially through the thickness of the second structure 60 starting from the outer surface of the second structure 60, such that the second structure 60 is substantially scored through while the first structure 40 is left intact.

Additionally, it is within the scope of the invention to laser-score one of the first structure or the second structure and to kiss cut or otherwise mechanically score the other. This can be advantageous, for example, when one of the structures making up the laminate 30 is readily scored by a laser but the other structure is not. For instance, when the first structure 40 is a polyester such as PET, it can readily be scored with a laser, but if a polyethylene heat seal layer is employed on the second structure 60, laser scoring may not be the best choice because polyethylene does not score well with a laser. In this case, kiss cutting or other mechanical scoring can be used to score the second structure 60.

After the scoring operation, the laminate 30 can be sent to a reel-up or take up roll 150 and wound into a roll for subsequent processing. Alternatively, it is possible for the reel-up operation to be omitted, such that the laminate 30 is directly advanced to a fill and seal station.

The laminate 30 can also be slit into a plurality of partial widths and wound into multiple rolls. In this latter instance, each partial width would have the recurring patterns of pressure-sensitive and permanent adhesives applied with suitably configured adhesive applicators to the full-width material, and would have the recurring score lines formed by suitably configured scoring devices acting on either the full-width laminate prior to slitting or acting on each partial-width portion after slitting.

FIG. 3 shows a flexible package 10 in a closed position made according to the process described above. The package 10 includes an outer portion that envelopes the package contents and is sealed to enclose the contents. The outer portion comprises a laminate 30 made by a method in accordance with the invention, such as the laminate previously described. The outer portion is manipulated and sealed along seal lines.

In the illustrated package, the score lines 122, 142 are provided to be on a front surface 16 of the package 10. The area of the package 10 bounded by the score lines can constitute any fraction of the total front surface of the package, but advantageously the area is a majority of the total surface area of front surface 16.

Based on the previous description of the laminate 30 and its formation process, it will be appreciated that the presence of the score lines has little or no impact on the barrier function of the package 10 because each score line 122, 142 extends only partially through the total thickness and the score lines are not aligned with each other. Additionally, the pressure-sensitive adhesive 92 fills the space between the score lines so that even if the score lines overlap somewhat in the thickness direction, there is still no open route between them. Furthermore, the score lines typically have a small width, on the order of a few thousandths of an inch.

Various materials can be used for the construction of the package 10. As noted above, the first structure 40 that forms the outer surface of the package 10 may comprise a single layer of flexible material or several layers of various materials. One material is a polyester such as polyethylene terephthalate (PET). As noted, the PET layer can be reverse-printed if desired, although alternatively it can be printed on its exterior and covered by an over-lacquer (not shown). The second structure 60 forming the inner surface of the package 10 may comprise a barrier layer and a sealant layer. The sealant layer constitutes the innermost surface of and can comprise various sealant materials such as heat seals or cold seals. Heat seals generally are preferred because they provide stronger seals than cold seals typically are capable of achieving. Any suitable heat seal material can be employed, such as polyethylene, polypropylene, ionomer resins such as SURLYN®, or others.

The barrier layer can comprise any of various barrier materials including barrier polymer films such as: ethylene vinyl alcohol copolymer (EVOH), polyamide, and the like; metallized polyolefin films such as polyethylene, polypropylene, oriented polypropylene, and the like; AlOx-coated polymer films; SiOx-coated polymer films; metal foil; and others. The barrier layer and sealant layer can be joined in various ways, including adhesive lamination, extrusion lamination, or coextrusion.

The laminate 30 may also include a metallization layer or a metal foil layer between the first structure 40 and the second structure 60, for example by providing a metallization layer on the surface that faces the first structure 40. This is beneficial in enhancing the barrier performance of the laminate 30. The metallization layer or metal foil layer can also be helpful when a laser is used for scoring the second structure 60. In particular, when the sealant layer comprises polyethylene, which is not as readily scored by laser as some other materials such as polyester, it can be difficult to employ a sufficiently high laser energy to score through the polyethylene sealant layer without scoring through the laminate 30 more deeply than desired. In particular, it is undesirable to score the entire thickness of the laminate. The metallization layer or metal foil layer can be helpful in “tuning” the laser to penetrate only up to the metallization layer or foil layer.

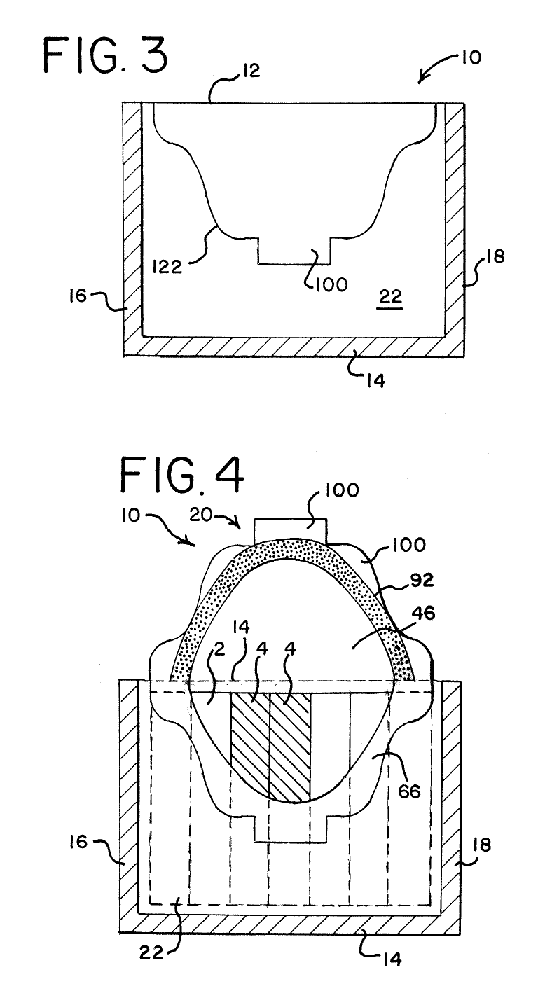

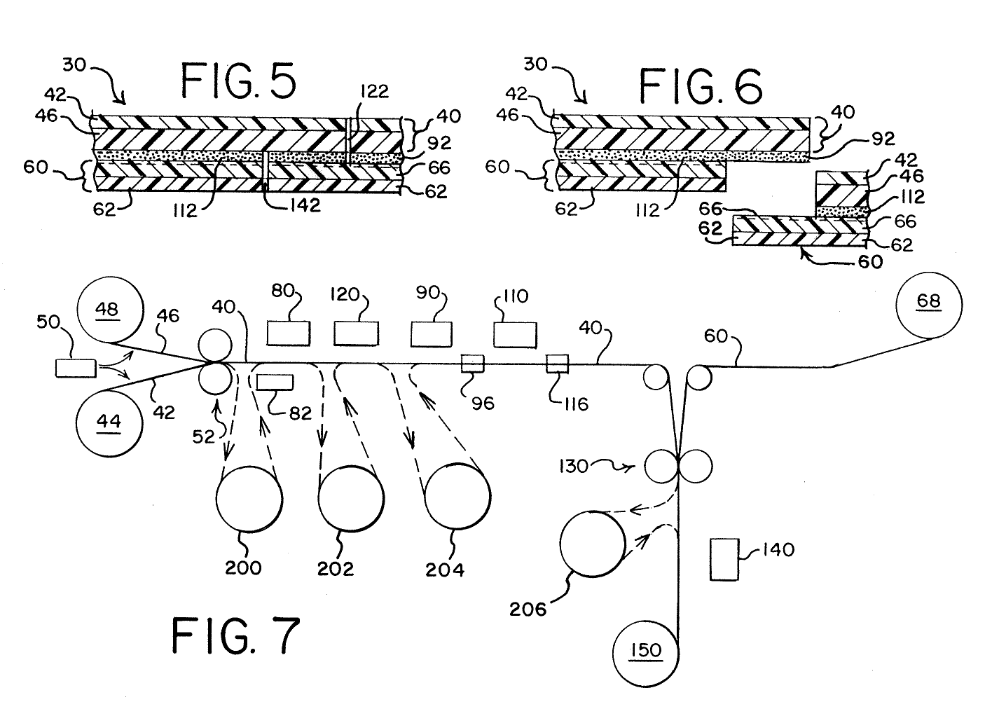

The function of the resealable flap provided by the pattern-applied adhesives and the score lines will now be described. With reference to FIGS. 3 and 4, the package 10 is shown in a closed condition (FIG. 3), for example as initially filled and sealed in a packaging plant. The package 10 has edges 14, 16, 18, that are sealed to each other with a top edge 12 that may be formed by folding the laminate 30 on itself. On the front surface 22, the first or outer structure is adhesively joined to the second or inner structure via the permanent adhesive. The outer score line 122 bounds an outer opening portion of the outer structure. In this embodiment, the outer opening portion has a generally U-shaped or smile shaped perimeter having three sides defined by the score line 122, and is attached to the remainder of the outer wrapper along a fourth side (i.e., an imaginary line extending between the free ends of the two legs of the U-shaped score line). The inner score line 142 is also generally U-shaped or smile shaped with its portions parallel to adjacent portions of the outer score line 122, but is spaced inwardly of the outer score line 122 so as to define an inner opening portion of smaller area than the outer opening portion. Accordingly, there is a marginal region of the outer opening portion that extends beyond the edge of the inner opening portion. The pressure-sensitive adhesive 92 is disposed between this marginal region and an underlying surface of the inner structure. The outer opening portion and inner opening portion are permanently joined by the permanent adhesive.

Consequently, when the outer opening portion is detached from the outer wrapper along the outer score line 122 and is peeled back as depicted in FIG. 4, the inner opening portion remains affixed to the outer opening portion and comes with it, thereby creating an opening in the front surface 22 as defined by the inner score line 142. The outer and inner opening portions essentially form a flap 20 that remains attached along a hinge line defined between the free ends of the two legs of the U-shaped score lines.

The outer structure preferably has a greater affinity for bonding with the pressure-sensitive adhesive 92 than does the surface of the inner structure, and hence the pressure-sensitive adhesive 92 is detached from the surface and remains attached to the marginal region of the outer opening portion. The package 10 is reclosable by re-attaching the pressure-sensitive adhesive 92 to the surface of the inner structure to restore the package 10 to the condition shown in FIG. 3.

The greater bonding affinity of the outer structure can be achieved in various ways. When the outer structure comprises a layer of PET and the layer of the inner structure to which the pressure-sensitive adhesive 92 is attached comprises a polyolefin such as polypropylene, oriented polypropylene, or metallized oriented polypropylene, the PET will naturally have a greater affinity for bonding to the adhesive than will the polyolefin layer. Additionally or alternatively, the surface of the outer structure can be treated, as previously noted, by corona discharge or flame treatment, to increase the surface energy and enhance the bonding affinity. It is also possible, as already noted, to control the bond strength of the pressure-sensitive adhesive to the layer by including an additive in the adhesive to reduce the bond strength, if desired.

Although it is preferred to have the pressure-sensitive adhesive 92 be applied to the outer structure and to remain on the outer structure upon opening, it is also within the scope of the invention to apply the pressure-sensitive adhesive to the inner structure and to remain on the inner structure upon opening. This is less preferred, however, because of the greater tendency for crumbs or the like from the contained products to become adhered to the pressure-sensitive adhesive and thereby reduce its adhesiveness with repeated openings and reclosings. It is believed that this tendency is reduced when the pressure-sensitive adhesive remains with the outer structure, since it is out of the way of the package opening when products are being removed.

It will be appreciated from the above description that laminates made in accordance with the invention inherently provide a tamper-evidence function for a package because after opening it is very difficult or impossible to replace the opening portions in such a way as to achieve a completely smooth, flush condition with the surrounding portion of the laminate. It tends to be readily ascertainable that the package has been opened. When printing is included on the laminate, it is even more noticeable when the package has been opened because it is difficult to achieve perfect registration of the printed matter across the score line when reclosing the package.

Additionally, other tamper-evidence features can be incorporated into the packaging structure. For example, when the outer structure is reverse-printed with ink, an area on the marginal region of the outer opening portion can first be treated (such as by applying a release coating or the like) to reduce the adherence of the ink so that when the package is first opened, the ink on the area of the marginal region detaches from the marginal region of the outer opening portion and remains with the pressure-sensitive adhesive on the inner structure adjacent the package opening. The release coating can be applied in a pattern (e.g., spelling out a word such as “Opened” or the like). Other types of tamper-evidence features can be included.

Referring back to FIG. 4, the package 10 of the present invention is shown with the resealable flap 20 in an open position to expose the contents of the package 10. The package 10 includes opposed major surfaces only one of which is shown, an opposed top and bottom, and opposed ends or sides. One of the major surfaces is scored to define a resealable flap 20 that can be opened to expose the contents stored within the package.

The package of the present invention is shown as containing sticks (or tabs) of gum 2. It is to be understood, however, that the use of the package 10 is not limited to gum, confections, or even consumable products. Therefore, as is known, gum sticks 2 may be elongate rectangular shaped members that are individually wrapped with a wrapper 4 in a conventional fashion. The wrapper 4 may be a rectangular shaped member typically made of paper or foil. Typically, the longitudinal edges of the wrapper 4 are overlapped and the ends of are turned over against the stick to enclose the stick completely.

FIG. 1 variously shows unwrapped gum sticks 2 and gum sticks contained in wrappers 4, where the gum sticks were individually wrapped prior to being placed in the package. The wrapper may be a single sheet or may include plural sheets or layers. It is noted that the gum sticks can be placed in an array directly into the package, without being individually wrapped.

While FIG. 1 shows the gum sticks aligned in a single row, it is to be understood that the gum sticks (wrapped or not) can be placed in a face-to-face manner, i.e., in two or more columns to form the array. When two or more columns are provided, each row may be encircled partially or completely by a wrapper to better contain the individual gum sticks. The array of gum sticks is placed in the package and are retained and enclosed. A portion of the inside of the package may contain an adhesive to releasably secure the gum sticks until the consumer removes them from the package.

Although it is not depicted, it is contemplated that one or more gum sticks may be contained within a flexible package and that one or more flexible packages may be provided in the package 10. For example, it is currently known to provide a flexible package for containing five sticks of gum. These flexible packages (or portions of them such as a bottom portion) may be stored in the package 10.

It should be noted that the terms “line of weakness” and “score line” as used herein refer either to a complete cutting through of one or more layers of the laminate or to a weakening of such layer(s) allowing the layer(s) to be severed along the score line.

The foregoing detailed description has described only a few of the many forms that this invention can take. For this reason, this detailed description is intended by way of illustration, and not by way of limitation. It is only the following claims, including all equivalents, which are intended to define the scope of this invention.

1. A method for making a flexible packaging laminate having a reclose feature, comprising:
a. advancing a first structure comprising at least one layer of flexible material to a first scoring station at which an outer score line is formed;
b. applying a pressure-sensitive adhesive onto one surface of the first structure;
c. applying a permanent laminating adhesive onto the one surface of the first structure such that the permanent adhesive does not cover the pressure-sensitive adhesive;
d. adhesively joining the first structure to a second structure via the permanent adhesive so as to form a laminate, the second structure comprising at least one layer of flexible material; and,
e. advancing the laminate to a second scoring station at which an inner score line is formed on the second structure wherein the outer score line is for an outer opening portion of the first structure that is separable from the first structure along the outer score line, the inner score line is for an inner opening portion of the second structure that is affixed to the outer opening portion by the permanent adhesive and is separable from the second structure along the inner score line.

2. The method of claim 1, wherein at least one of the score lines are formed with a laser.

3. The method of claim 1, wherein at least one of the score lines are formed by mechanical scoring.

4. The method of claim 1, wherein one of the score lines is formed with a laser and the other score line is formed by mechanical scoring.

5. The method of claim 1, wherein the score lines and the pressure-sensitive adhesive are formed to be generally U-shaped such that the outer and inner opening portions form a flap that remains attached to the laminate along-a hinge extending between legs of the U-shaped score lines.

6. (canceled)

7. The method of claim 1, wherein the first structure has a greater bonding affinity to the pressure-sensitive adhesive than does the second structure.

8. The method of claim 7, wherein the first structure includes polyester and the second structure has a layer of polyolefin forming an underlying surface to which the pressure-sensitive adhesive is attached.

9. (canceled)

10. The method of claim 1, wherein the pressure-sensitive adhesive and permanent adhesive is applied in a recurring pattern spaced apart along a length of the first structure.

11. The method of claim 10, wherein the first scoring station forms score lines in the first structure at intervals spaced apart along the first structure.

12. The method of claim 1, wherein the second structure is a coextruded web comprising a barrier layer and a sealant layer.

13. The method of claim 1, wherein the second structure has a barrier layer facing the first structure and a sealant layer on an opposite side of the barrier layer from the first structure.

14. The method of claim 1, further comprising forming a tamper-evidence feature in the laminate such that initial opening of the built-in opening and reclose feature causes the tamper-evidence feature to be visible adjacent the opening in the laminate.

15. The method of claim 14, wherein the step of forming the tamper-evidence feature comprises treating an area of the region of the outer opening portion to readily release from ink, and printing ink onto said region over said area prior to applying the pressure-sensitive adhesive.

16. The method of claim 1 wherein the outer score line is formed in registration with one or more of printing, indicia, and the pattern of pressure sensitive adhesive.

17. The method of claim 1 wherein the outer score line is formed through the thickness of the first structure.

18. The method of claim 1 wherein the inner score line is formed through the thickness of the second structure.

19. The method of claim 7, further comprising the step of treating the one surface of the first structure with a corona or flame treatment to enhance bonding affinity with the pressure-sensitive adhesive such that the pressure-sensitive adhesive tends to remain adhered to the outer opening portion and to detach from a underlying surface of the second structure when the opening portions are peeled back.
